(19) United States
(12) Patent Application Publication
(10) Pub. No.: US 2026/0332814 A1
(43) Pub. Date: Oct. 22, 2026

(54) ENHANCED VIDEO

(71) Applicant: VIDHANCE AB, Uppsala (SE)

(72) Inventors: Erik Hägglund, Stockholm (SE); Nils Hulth, Uppsala (SE)

(21) Appl. No.: 19/490,290

(22) PCT Filed: Jul. 9, 2024
(86) PCT No.: PCT/EP2024/069321

§ 371 Date: Dec. 4, 2025

(30) Foreign Application Priority Data
Jul. 14, 2023 (SE) 2350896-3

(51) Int. Cl. H04N 19/587; G06T 7/20; G06V 20/52; H04N 19/132; H04N 19/172

(52) U.S. Cl. CPC H04N 19/587; G06T 7/20; G06V 20/52; H04N 19/132; H04N 19/172

(57) ABSTRACT

Embodiments of the present disclosure may include a method performed in a camera device, for enhancing video output quality for a captured video sequence, the camera device including one or more motion sensors and/or software, to monitor motion of the camera device, method including capturing a video sequence including a first stream of image frames at a first frame rate using a camera in the camera device Embodiments may also include continuously monitoring the motion of the camera device, using the one or more motion sensors and/or software, during the capturing of the video sequence to obtain motion information. In some embodiments, the motion information may include at least one motion parameter related to each image frame indicating a motion of the camera device during the capturing of the image frame. The methods may provide simple methods for obtaining enhanced video.

### TECHNICAL FIELD

The present disclosure relates capturing of enhanced video. More specifically, the proposed technique relates to methods in a camera device for inserting copies of image frames to obtain enhanced video. The disclosure also relates to corresponding devices and to a computer program for executing the proposed methods, and to a carrier containing said computer program.

### BACKGROUND

Video coding relates to a process of compressing video data to reduce its size for storage or transmission. It involves techniques such as motion compensation, inter-frame prediction, and entropy coding to exploit spatial and temporal redundancies in video sequences. Video coding is used to efficiently encode and transmit video content, enabling high-quality video streaming, video conferencing, multimedia applications, and efficient storage of large video files. By reducing the size of video data without significant loss in quality, video coding enables improved bandwidth utilization, reduced storage requirements, and enhanced video playback across various devices and networks.

There are a number of challenges when transmitting and coding video, such as bad connections limiting the available bandwidth, limited power or desire to minimize power use, while trying to maintain video quality. Thus, enhanced methods for coding and transmitting video are needed.

### SUMMARY

An object of the present disclosure is to provide methods and devices which seek to mitigate, alleviate, or eliminate the above-identified deficiencies in the art and disadvantages singly or in any combination. This object is obtained by a method performed in a camera device, for enhancing video output quality for a captured video sequence, the camera device including one or more motion sensors and/or software to monitor motion of the camera device, the method comprising capturing a video sequence including a first stream of image frames at a first frame rate using a camera in the camera device, continuously monitoring the motion of the camera device, using the one or more motion sensors and/or software, during the capturing of the video sequence to obtain motion information. In some embodiments, the motion information may include at least one motion parameter related to each image frame indicating a motion of the camera device during the capturing of the image frame. The method further comprises adding a number of intermediate frames in the first stream of image frames to obtain a second stream of image frames, wherein the adding may include selecting a number of image frames from the first stream of image frames based on the motion parameters of the image frames, copying the selected image frames to obtain intermediate frames, and inserting the intermediate image frames in the first stream of image frames to obtain the second stream of image frames.

In some aspects is provided a camera device (10), configured to enhance video output quality for a captured video sequence, the device including a camera (11), one or more motion sensors and/or software (12), a memory (13), a communication interface (14), and processing circuitry (15) configured to cause the camera device (10) to capture, using the camera, a video sequence including a first stream of image frames at a first frame rate using a camera in the camera device, continuously monitor, using the one or more motion sensors and/or software, the motion of the camera device during the capture of the video sequence to obtain motion information, wherein the motion information may include at least one motion parameter related to each image frame indicating a motion of the camera device during the capture of the image frame. Embodiments may also include to add a number of intermediate frames in the first stream of image frames to obtain a second stream of image frames, wherein to add a number of intermediate frames may include to select a number of image frames from the first stream of image frames based on the motion parameters of the image frames, copy the selected image frames to obtain intermediate frame, and insert the intermediate image frames in the first stream of image frames to obtain a second stream of image frames.

According to some aspects, the disclosure proposes a computer program comprising computer program code which, when executed in a camera device, causes the camera device to execute the methods described below and above.

According to some aspects, the disclosure proposes a carrier containing the computer program, wherein the carrier is one of an electronic signal, optical signal, radio signal, or computer readable storage medium.

Other objects and advantages will become apparent to those skilled in the art from a review of the ensuing detailed description, which proceeds with reference to the following illustrative drawings, and the attendant claims.

### BRIEF DESCRIPTION OF THE DRAWINGS

FIG. 1 is a flowchart of an exemplary method for enhancing video output quality for a captured video sequence of the present disclosure.

FIG. 2 is a block diagram illustrating a camera device configured to provide enhanced video output quality for a captured video sequence.

The figures are not necessarily to scale, and generally only show parts that are necessary in order to elucidate the inventive concept, wherein other parts may be omitted or merely suggested.

### DETAILED DESCRIPTION

Aspects of the present disclosure will be described more fully hereinafter. The apparatus and method disclosed herein can, however, be realized in many different forms and should not be construed as being limited to the aspects set forth herein.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some embodiments a non-limiting term “mobile device” or “wireless device” is used. The mobile or wireless device herein can be any type of device capable of communicating with a network node or another mobile device over radio signals or wired communication. The mobile device may be a wireless device, and may include a radio communication device, target device, device to device (D2D) wireless device, machine type wireless device or wireless device capable of machine to machine communication (M2M), a sensor equipped with a wireless device, iPad, Tablet, mobile terminals, smart phone, laptop, headset, smart glasses, embedded equipped (LEE), laptop mounted equipment (LME), etc.

In some embodiments a non-limiting term “camera device” is used. The camera device herein can be any type of mobile device comprising a camera, such as a smartphone, iPad, Tablet, headset, smart glasses or mobile terminal etc., as discussed above.

Video coding typically comprises encoding the video at a transmitter side and decoding at a receiver side. Thus, the term “coding” refers to both the “encoding” and the “decoding”. Transmitting raw video data is not always possible due to its large size, and hence the video is compressed before transmitting. Also regarding storage, the size is of importance. A codec in video coding is a set of algorithms and specifications used for compressing and decompressing video data, and typically consists of two main components; an encoder and a decoder. Encoding is the process of compressing raw video data into a compact and efficient format for storage or transmission involving analyzing the video frames, removing redundancies, and encoding them using compression algorithms. The encoder utilizes techniques like motion estimation, transform coding, and entropy encoding to reduce the size of the video while maintaining an acceptable level of visual quality. Video decoding is the reverse process of video encoding, involving receiving the compressed video data and reconstructing the original video frames. The decoder utilizes decoding algorithms to decode the compressed data, apply inverse transformations, and generate the final video frames for display or further processing. Video encoding and decoding of video communication systems enables efficient storage, transmission, and playback of high-quality video content. Codecs are responsible for achieving efficient video compression while minimizing the loss of visual quality. There are numerous video codecs available, each with its own advantages and trade-offs. Popular examples include H.264/AVC, H.265/HEVC, VP9, and AV1. The choice of codec depends on factors such as desired compression ratio, computational complexity, available bandwidth, and compatibility with playback devices.

Video frames refer to individual images that compose a video sequence. Each frame is a static representation of the video at a particular point in time and consists of a grid of pixels. The resolution of video frames determines the number of pixels in each frame, such as 1920×1080 for Full HD or 3840×2160 for 4K Ultra HD. The frame rate of a video refers to the number of frames displayed per second (fps). Common frame rates include 24 fps, 30 fps, and 60 fps, which may also be measured in Hertz (Hz), where 1 fps equalizes 1 Hz. A higher frame rate provides smoother motion and is often used for fast-action content, while a lower frame rate is typically suitable for slower-paced videos. The frame rate, along with the resolution, affects the visual quality and smoothness of video playback, and they are essential parameters to consider when capturing, editing, and displaying video content.

The camera of the camera device may capture a “stream of image frames”, such as N subsequent image frames in a stream, which image frames thus refer to such video frames, where “image frame” and “video frame” may be used interchangeably herein. Also the terms “image” or “frame” may be used herein to refer to such image frames. The stream of image frames comprises a number of consecutive image frames in time, wherein a specific image frame may be referred to as a current image frame, where a previous image frame is an image frame occurring before the current image frame, and a following image frame is an image frame occurring after the current image frame in the sequence of image frames, and in time. An image frame may be copied and inserted into an existing sequence of image frames, and thus be referred to as an “intermediate image frame”. The copy of an image frame may be transformed based on motion data of the camera device, such as transformed based on motion data between said current image frame and a consecutive following image frame, the intermediate frame being referred to as an intermediate copy of a first and a second image frame, to denote that the copy is based on one image frame and transformed based on the other, or may be referred to as an intermediate copy of a first or second frame that is based on the first or second image frame, and transformed based on e.g. the other frame. The first (current) image frame is transformed based on the motion occurring between said frame and a second (following) image frame, such that the intermediate copy comprises half of the motion (in relation to time), both rotational and translational, compared to the second image frame, i.e. the motion which has passed during half of the time between capturing of the first and the second image frame. The motion compensation is calculated based on the movement of the device during the capture of the N subsequent frames, and the motion compensation between frames is then interpolated. Thus, the intermediate copy may reflect how far the image frame has moved after half of the time between capturing of the first and second image frame. In some instances, if the motion is constant, then the whole frame will be moved half of the global distance that the camera device moved between capturing said images. In other instances, non-constant motion compensation is applied in anticipation of future movements, The copy may also be an identical copy of a previous image frame, wherein the intermediate image frame is a double of the previous (or following) image frame.

In some embodiments, the motion compensation for frame N is computed or derived based on the motion between all frames between N and N+M, where M is a latency parameter. Thus, the first (current) image frame is transformed based on the motion between said frame, and a some (later) image frame. Similarly a second (following) image frame is transformed based on the motion between said frame, and some (later) image frame. An intermediate copy is then transformed based on the half of the transformation of the first frame, and the second frame.

Video coding is commonly achieved through the use of video compression standards such as H.264/AVC or H.265/HEVC, using motion vectors and I (intra), P (predicted), and B (bidirectional) frames. A typical process may start with video sequence partitioning of dividing the video sequence into groups of frames called GOPs (Group of Pictures). A GOP typically consists of one I-frame followed by several P-frames and B-frames. The process is followed by I-frame compression, encoding the I-frame (intra-frame) as a standalone frame, where the I-frame does not rely on any other frame for reconstruction and serves as a reference for subsequent frames. Next motion estimation and P-frame compression is performed, comparing the current frame with the previously encoded I-frame or P-frame to estimate the motion vectors. Motion estimation identifies regions of the frame that exhibit motion and determines the corresponding motion vectors. The motion vectors represent the displacement of each block within the frame. The P-frame is then compressed by encoding the difference between the current frame and the motion-compensated prediction based on the motion vectors. This difference, known as the residual, is compressed using techniques such as DCT, quantization, and entropy encoding. To further exploit temporal redundancy, bidirectional motion estimation is performed between the current frame and both preceding and subsequent frames. This involves estimating motion vectors in both directions. The B-frame is then compressed by encoding the difference between the current frame and the motion-compensated predictions from both the preceding and subsequent frames. The motion vectors and residuals are compressed similar to P-frames. The next step is entropy coding and bitstream generation, perform entropy coding techniques, to further reduce the data size. After the video has been send to a receiver, it is decoded on the receiving end. On the decoder side, the encoded bitstream is received and decoded. The reverse process is performed, where motion vectors are used for motion compensation, and the residuals are inverse transformed and added to the predicted frame to reconstruct the original frame. This process of encoding and decoding using motion vectors and different frame types enables efficient video compression by exploiting spatial and temporal redundancies. Even though it reduces the required bit rate for video transmission or storage while maintaining acceptable video quality, the process requires a lot of processing power.

There are a number of parameters to take into account when coding and transmitting video, including the current available bandwidth, the desired output quality at the receiver side, and the processing capabilities. The perceived quality of the video may depend on the number of frames per second (frame rate) as discussed above, but having a higher frame rate will affect the bitrate, and thus demands on the system, such as higher bandwidths, processing capabilities and will use more power to compute. Frame rate has a significant impact on the bitrate in video coding, i.e. the amount of data needed to represent a video stream per unit of time, typically measured in bits per second (bps). Higher frame rates require more data to accurately capture and represent the motion within the video.

When encoding a video, the bitrate allocation is typically distributed among the frames based on their complexity and importance. Higher frame rates result in more frames per second that need to be encoded, leading to an increased number of bits required to represent the video accurately. This is because a higher frame rate demands more frequent updates of pixel information, resulting in a higher level of detail in the video. For example, if the frame rate is doubled from 30 fps to 60 fps while keeping other encoding parameters constant, the encoder will need to allocate more bits to each frame to maintain a similar level of quality. Consequently, the bitrate will increase as more data is required to represent the increased frame rate adequately. Having more frames to encode will increase demand on bandwidth and increase energy consumption, and the video will also require larger storage space.

Therefore, when choosing the frame rate for video coding, it has been necessary to consider the desired level of smoothness and motion detail versus the available bitrate and the limitations of the playback and transmission systems. Higher frame rates offer smoother motion but require higher bitrates, which may impact storage, bandwidth, or streaming capabilities. Thus, it would be desirable to maintain a good quality at a lower bitrate.

Frame rate up conversion, also known as frame rate conversion or frame rate upscaling, is a process that involves increasing the frame rate of a video sequence. It is used when the original video has a lower frame rate than the desired playback or display frame rate. Frame rate up conversion can be achieved through various techniques, such as:
i) Frame Interpolation, also known as frame upsampling, involving generation of intermediate frames between existing frames using motion estimation and interpolation algorithms, to create a smoother and more fluid visual experience. By analyzing the motion and content of adjacent frames, frame upsampling algorithms estimate the movement of objects and generate new frames that bridge the gap between the original frames, where new frames are synthesized to bridge the gap and increase the temporal resolution of the video. These interpolated frames are created by blending the information from neighboring frames, effectively increasing the temporal resolution of the video.
ii) Motion-Compensated Frame Doubling/Tripling, involving utilizing motion vectors to estimate the motion between frames and then repeating the frames to increase the frame rate.
iii) Motion-Compensated Temporal Smoothing, which aims to reduce the jerkiness and judder caused by low frame rates. It involves applying temporal smoothing algorithms to blend and smooth the motion between adjacent frames, resulting in a visually smoother playback.

Frame rate up conversion is commonly used in various applications, including video playback systems, video editing, broadcasting, and multimedia content delivery. It helps enhance the visual quality and fluidity of videos by increasing the frame rate to match the desired viewing experience or display capabilities, where the quality of the up-converted frames depends on the specific algorithms and techniques employed, as well as the original video content and the target frame rate.

Thus, frame rate up conversion comprises using various algorithms and motion data on a pixel level to synthesize new frames, thus increasing the amount of data and bitrate.

For example, interpolation/upsampling of video may involve utilizing the motion information provided by the motion vectors to generate interpolated frames between existing frames. The process generally comprises i) Motion vector estimation, where the video codec, during the encoding process, estimates motion vectors for each macroblock or block of pixels in consecutive frames. The motion vectors represent the displacement or motion of the macroblocks between frames. ii) Motion compensation, where the motion vectors are used to predict the position of each macroblock in the current frame by referencing the previous frame. This is known as motion compensation. The predicted macroblocks serve as a baseline for the generation of interpolated frames. iii) Interpolation, where, based on the motion vectors and motion-compensated predictions, new frames are generated by interpolating pixel values between the original frames. Various interpolation techniques such as linear interpolation, bicubic interpolation, or optical flow estimation can be used to estimate the pixel values of the interpolated frames. iv) Frame integration, where the interpolated frames are then inserted into the video sequence, effectively increasing the frame rate. These additional frames provide smoother motion and reduce the judder that may occur with a lower frame rate.

In video coding, motion vectors are calculated by comparing blocks of pixels, typically referred to as macroblocks, between adjacent frames. By analyzing the differences in pixel values, motion estimation techniques determine the direction and magnitude of the displacement of these macroblocks. The motion vector describes the amount of horizontal and vertical shift required to align a macroblock in the current frame with its corresponding position in the reference frame.

The process of upsampling video using motion vectors leverages the motion information captured by the motion vectors to estimate the appearance of the video frames between the original frames. This interpolation helps improve the temporal resolution and visual smoothness of the video, resulting in a more fluid and visually appealing playback experience. For example, the decoder may receive the compressed video stream and reconstruct the original frames where, if the encoded video has a lower frame rate than desired, the decoder can employ frame upsampling techniques to generate additional frames between the decoded frames to improve the visual smoothness and motion clarity of the playback by increasing the effective frame rate.

Frame rate up conversion, increasing the frame rate of a video sequence, typically affects the bitrate in video coding. When performing e.g. frame upsampling, additional frames are generated between the original frames to increase the frame rate. These interpolated frames introduce new information and details, resulting in an increase in temporal resolution. As a result, the bitrate required to represent the video sequence accurately will increase. The increased frame rate means more frames per second need to be encoded and transmitted. Each frame contains a certain amount of visual information, and transmitting more frames will require additional data to represent the increased details and motion within the video. Therefore, the bitrate will typically rise as a result of frame rate up conversion such as frame upsampling. Different algorithms may introduce varying levels of complexity and efficiency, resulting in different bitrate requirements. Additionally, the complexity of the video content itself, such as the amount of motion and detail, can influence the required bitrate when upsampling the frames. Thus, frame upsampling leads to an increase in the bitrate as more frames are introduced, requiring additional data to represent the increased temporal details and motion within the video sequence.

It has now surprisingly been found that by altering the video before encoding, by adding intermediate copies of already existing frames based on global motion data, the video quality may be significantly increased, while maintaining a lower bitrate. The global motion data (camera motion) may either be sensed via one or more motions sensors, or estimated based on optical flow data using a software, or a combination thereof. The added frames may be copies or intermediate copies of existing frames, where the frames are copied based on global motion of the camera device capturing the video. Thus, instead of using complex algorithms and pixel based motion vectors, the global motion of the camera itself may be used to generate intermediate copies of the frames. As the added frames will be similar or identical copies of existing frames, the bitrate will not be significantly increased. The new video sequence will have more or less the same size (file size) and bandwidth requirements, but with enhance quality. The codec will not need to spend extra processing power to encode and decode these frames (no need to recreate intermediate copies), as they are very similar or identical to other encoded and decoded frames. Noise of the copied frames, and potential exposure differences between frames, will neither need to be coded. In addition, even before this, already from the capturing of the video sequence, power will be saved in all the steps performed. Thus, the bitrate will be kept low, and bandwidth, storage memory and power will be saved.

The motion may be monitored using one or more motion sensors in connection with the camera device. A motion sensor in mobile device, such as a smartphone, is a component that enables the device to detect and measure various types of motion. It typically consists of multiple sensors, including an accelerometer, gyroscope, and magnetometer. The accelerometer detects linear acceleration and tilt, allowing the smartphone to sense changes in orientation, shake, or movement in a particular direction. The gyroscope measures angular velocity and rotation, providing precise information about the device's orientation and rotational movements. The magnetometer, also known as a digital compass, detects magnetic fields and aids in determining the smartphone's absolute orientation relative to the Earth's magnetic field.

Capturing motion of a camera while filming with a motion sensor, such as a gyroscope, attached to the camera device typically comprise attaching the motion sensor, like a gyroscope, securely to the camera or its support system and ensure that it is properly calibrated and aligned with the camera's orientation. It may also be integrated into the camera device. The sensor is enabled to capture data continuously during filming for data acquisition. The sensor will measure the camera's movements and rotations in real-time, providing information about its position and orientation changes. For data integration, to capture the video footage simultaneously while recording motion sensor data, it is essential to synchronize the timestamps of the video frames and the corresponding sensor readings, to align them accurately during analysis. After capturing the footage, it is possible to analyze the motion sensor data along with the video frames. The gyroscope readings can provide information about camera movements, rotations, and tilts. By examining this data, it is possible to obtain motion information regarding the camera's motion patterns during filming, even to assess the current motion of the camera during the capturing of a specific image frame, which may be incorporated into the motion parameters of each image frame. Hence, the motion parameter of each image frame may be used to assess the current motion of the image frame, including both rotational, translational movement.

The motion sensor may be any type of sensor described above, or a combination thereof, such as a combined accelerometer and gyroscope, or an inertial measurement unit. An inertial measurement unit (IMU) is a sensor unit with a combination of accelerometers, gyroscopes and magnetometer sensors, thus capable of easily calculating orientation, position, and velocity of a camera device. Thus, motion information (data) from the IMU may be used in the methods of the current disclosure, which may be referred to as IMF data.

In some embodiments, a software may estimate the camera motion based on optical flow data, or the motion may be a combination of estimated motion data and sensed motion data from the motion sensors. Optical flow (data) represents the displacement of pixels between consecutive frames and estimating the motion of a camera based on optical flow data involves analyzing the apparent motion of objects in an image sequence. Optical flow represents the perceived displacement of pixels between consecutive frames, providing insights into the movement and velocity of objects within the video. The optical flow algorithm estimates the motion of pixels by analyzing the spatial and temporal changes in pixel intensity values. It determines the direction and magnitude of the pixel motion, generating a vector field that describes the flow of pixels between frames. This may include to extract optical flow by applying an optical flow algorithm, to compute the optical flow vectors for each pixel in consecutive frames, outliers may be removed, the camera ego-motion may be determined and the camera motion can be decomposed, i.e. decomposing the ego-motion into translational and rotational components. To convert the estimated motion into real-world units, the camera's intrinsic parameters (focal length, principal point, etc.) and potentially its extrinsic parameters (position and orientation) are used. To estimate the scale of motion, additional information such as known object sizes or scene depth information may be used. Any known camera motion estimation algorithm using optical flow may be implemented in the current device.

Thus, the motion parameters may also comprise additional data, such as optical flow data and also depth map data. A depth map of a video sequence is a representation of the scene's depth or the distance information for each pixel in the video frames. It provides an estimation of the 3D structure of the scene, indicating how far objects are from the camera. A depth map assigns depth values to each pixel based on its distance from the camera viewpoint. Typically, higher values indicate objects closer to the camera, while lower values represent objects farther away. The depth map can be represented as a grayscale image or a separate channel associated with each pixel in the video frames.

Patent application US2013/0329064 A1 relates to avoiding producing interpolated frames if the local motion (non-camera motion) is high, but in contrary to the present invention, it only looks at local motion on a pixel level, not global motion determined by sensors as in the present disclosure. The patent application refers to a pixel-level interpolation algorithm, which difference metric is only be useful to measure non-motion camera parameters on a pixel-level. This prior art technique is disabled/enabled based on the degree of local motion, and if the local motion is sufficiently low, it produces two interpolated frame candidates based on two different source frames. These two candidates are then compared with a difference metric, and if the difference is deemed small enough the frames go through a merging operation and the video is upsampled. On the contrary, in the proposed methods there is no need to produce two frames, compare, or merge them, because the methods copy a frame and interpolate a transformation based on the motion compensation, The difference between any interpolated frames in the proposed methods is uniquely determined by the total motion (global+local). Thus, what is interpolated in the prior art methods and the current methods are different things, and in the current methods there is no need for the comparator or merger operation that is performed in the prior art application. Thus, the prior art fails to disclose the proposed methods and their inherent benefits.

In an example of the proposed methods, a mobile device is filming (capturing a video sequence) at a frame rate of 30 fps. Additional frames are inserted in between all of the existing frames to increase the number of frames, and thus video quality. In the present example, the number of frames are doubled, such that one extra frame is inserted after each image frame in the original video. Thus, compared to capturing video at a frame rate of 60 fps, the corresponding bitrate is decreased, while the resulting video has an appearance of about 80-90% of a 60 fps video. Thus, enhanced video is attained.

In another example, a mobile device is filming at a frame rate of 30 fps, and additional frames are inserted in between some of the existing frames. Thus, a dynamic fps may be used. The global motion of the device is simultaneously monitored by one or more motion sensors, as described above. Based on the motion information from the motion sensor, the places where intermediate images would most benefit the resulting video is selected, and intermediate copies generated. For example, if the motion information (motion compensation) indicates large motion, especially rotational movement, between two consecutive image frames, these may be selected to generate an intermediate copy. The frame with the least intrinsic motion (motion blur) when being captured may also be selected as the one to be copied and transformed. A copied (intermediate) frame is inserted in the sequence of image frames, whereas a new sequence of image frames is obtained, having a greater quality that the original video.

For a pair of frames, such as a current and a following frame, where an intermediate frame is to be inserted, the global motion of the camera may be used for generating such an intermediate image transform, which is based on the movement/motion compensation, which in turn is based on N subsequent frames. Thus, the “intermediate frames” or “intermediate copies” are thus based on the global motion between a current frame and a following frame. As an example, if the camera device is translated sideways a certain distance X during a time Y between the capturing of the current and the following image, the intermediate frame may be generated as an image having corresponding location as an image frame captured at time ½Y would have, which when having constant motion would correspond to being moved half of the distance, i.e. ½X. If the motion would be accelerating, then the intermediate image would move less than ½X, and if the motion would be decreasing, then the intermediate image would move more than ½X. Similarly, if the camera is tilted or rotated, then the intermediate image will be tilted or rotated half the way (in time) between the current and the following image, such that the intermediate image become a mean of the global motion/motion compensation of the current and the following image frame, for example.

In some situations, objects will be close to the camera, and hence they will move significantly between two image frames. In such cases, instead of generating an intermediate frame based on the current and the following image frame, an identical copy of the current frame (or following frame) is inserted. Thus, in some embodiments, the intermediate image frame is an identical copy inserted after (or before) the copied image frame.

In other embodiments, if the current image frame has a lot of motion, and is blurry, i.e. if a motion parameter of the current image shows greater motion during the capture that the consecutive following image frame, said following image frame may instead be copied as the intermediate image frame, wherein the intermediate image frame is inserted between the current and the following image frame. This applies both for identical “raw” copies, and for intermediate copies where the second following image frame is selected as the basis for the intermediate copy, i.e. the copy made from second image frame, with or without transformation. The transformation in this base would then be “backwards”, i.e. calculated from the second image frame to the first image frame. In some instances, said second image frame may constitute a first image frame in a following pair of image frames to be processed, and may be selected to be copied also for this pair to generate an intermediate frame. Thus, the image frame may be used for generating two copies, one to be inserted before and one to be inserted after said image frame.

In some embodiments, more than one copy of an intermediate frame (identical copy or mean generated copy) is inserted in a row, for example two copies of a current frame may be added after the current frame. This may be used for example when the current image frame is of good quality, such as when the motion parameters of the copied frame show low motion during the capturing/filming of the current image frame.

Thus, the present invention provides new and simplified methods for achieving enhanced video quality without increased bitrates, thus saving energy, memory and bandwidth.

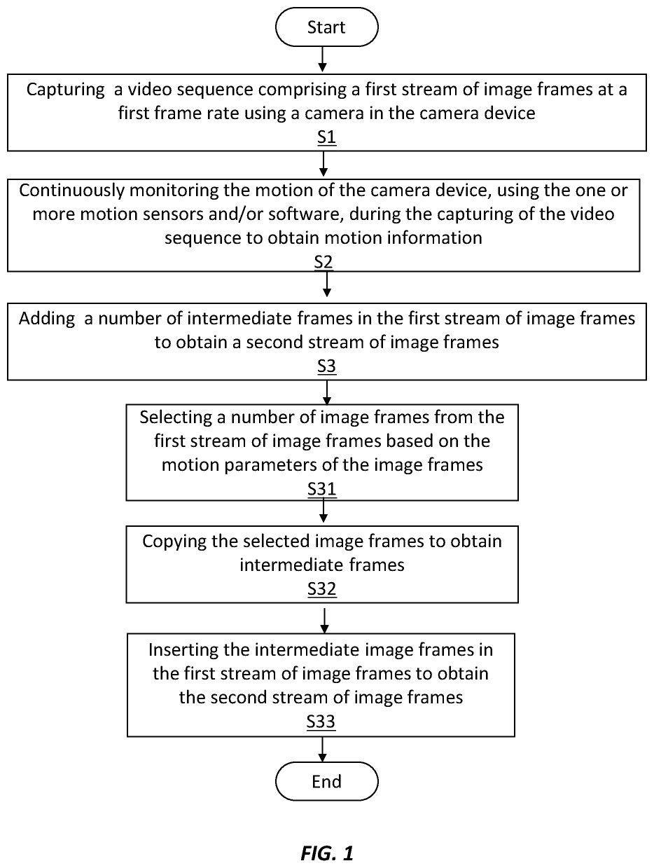

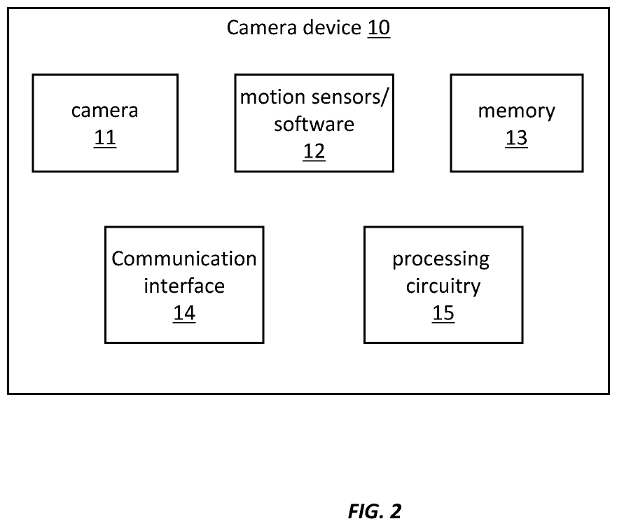

The proposed methods and devices will now be described in more detail referring to FIGS. 1 and 2. It should be appreciated that the operations do not need to be performed in order, unless explicitly stated or necessary for the process to work. Furthermore, it should be appreciated that not all of the operations need to be performed.

### Example Operations

FIG. 1 is a flowchart that illustrates a method, performed in a camera device, for enhancing video output quality for a captured video sequence, the camera device comprising one or more motion sensors to monitor motion of the camera device and/or software to estimate the motion, method comprising: capturing (S1) a video sequence comprising a first stream of image frames at a first frame rate using a camera in the camera device; continuously monitoring (S2) the motion of the camera device, using the one or more motion sensors, during the capturing of the video sequence to obtain motion information, wherein the motion information comprises at least one motion parameter related to each image frame indicating a motion of the camera device during the capturing of said image frame; and adding (S3) a number of intermediate frames in the first stream of image frames to obtain a second stream of image frames, wherein the adding comprises: selecting (S31) a number of image frames from the first stream of image frames based on the motion parameters of the image frames; copying (S32) said selected image frames to obtain intermediate frames; inserting (S33) the intermediate image frames in the first stream of image frames to obtain the second stream of image frames.

Thus, the motion of the camera may either be monitored using the one or more motion sensors, or estimated using a software based on optical flow data. The intermediate frame may be an identical copy of a selected image frame, added after said image frame, or the intermediate frame is based on a copy of the selected image frame, which is transformed using the motion information of the camera device. The transformation may include transforming the copied image in view of global motion from a motion sensor and/or software analyzing optical flow data, but may also comprise additional modifications. For example, corrections in view of the camera lens properties may be performed. As camera lenses can introduce various types of distortions (barrel distortion, pincushion distortion, and perspective distortion) and combinations of those, which can cause straight lines to appear curved or objects to appear stretched or compressed in the image, some modification may be needed to avoid this. Another example of transformation may also be rolling shutter correction, or correction for offset of the optical axis that can occur for example due to optical image stabilization (OIS).

Thus, a camera device may capture a first sequence of video comprising a first stream of image frames, add extra frames, denoted intermediate frames, to obtain a second stream of image frames, wherein said second stream of image frames comprises more image frames as compared to the first stream of image frames. As the intermediate frames will be so similar to the original frames, the processing demands on the codec, the size of the image file, and the bandwidth requirements will thus be similar as for the first stream, while the quality of the output video, i.e., the second sequence comprising a second stream of image frames, is significantly enhanced.

How many intermediate frames that are to be added may be determined in various ways. In some embodiments, all image frames in a stream of image frames are copied, or all image frames that has a consecutive following image frame, i.e. all but the last. Or an identical copy of the last frame may be added at the end. Alternatively, all image frames in a stream of image frames are checked for motion data, where if the motion between a current and a following image frame is above a threshold, an intermediate image may be generated.

Thus, in some embodiments, selecting a number of image frames from the first stream of image frames based on the motion parameters of the image frames comprises:
i) selecting all image frames in the first stream of image frames; or
ii) selecting a number of image frames in the first stream of image frames being fewer than a total number of image frames, wherein the frames being selected shows a (the) greatest difference in the motion parameters between two consecutive image frames.

When the image frames to be copied have been selected, each such currently processed image frame may be referred to as a “first image frame” having a consecutive following image frame (in time, in the first stream of image frames) being referred to as a “second image frame”. Movement of the camera device during the capturing of said image frames, and between the capturing of a first and second image frame may be evaluated, and the copying and transformation may depend on said motion, such as the type and amount of motion. If the camera is moving sideways (translational movement) at the same time as it moves in a rotational direction, objects that are close will look like they are vibrating, and thus frame copying and transformation should be avoided for such frames. Or an alternative transform that takes translation into account may be used.

Thus, in some embodiments, for all of the selected frames, wherein each image frame being selected to be followed by an added intermediate frame in the second stream of images is a first image frame, and each frame being a consecutive following image frame of a first frame in the first stream of image frames is a second image frame, the method further comprises: for each first and second image frame in the first stream of image frames,
on condition that the at least one motion parameter of the first image frame and the at least one motion parameter of second image frame indicate rotational movement only between the capturing of the first and the second image frame: generating an intermediate copy of the first image frame and the second image frame to obtain an intermediate image frame; and inserting the obtained intermediate image frame between the first and the second image frame in the second stream of image frames;
on condition that the at least one motion parameter of the first image frame and the at least one motion parameter of second image frame indicate both translational movement and rotational movement between the capturing of the first and the second image frame: determining whether any objects in the first and/or second image frame are close to the camera of the camera device; if it is determined that no object in the first and/or second image frame is close to the camera, generating an intermediate copy of the first image frame and the second image frame to obtain an intermediate image frame; and inserting the obtained intermediate image frame between the first and the second image frame in the second stream of image frames; if it is determined that an object in the first and/or the second image frame is close to the camera, generating an identical copy of the first or the second image frame to obtain an intermediate image frame; and inserting the obtained intermediate image frame between the first and the second image frame in the second stream of image frames. In some embodiments, one or more intermediate frame will always be inserted between each pair of image frames in the first stream of image frames;
on condition that the at least one motion parameter of the first image frame and the at least one motion parameter of second image frame indicate translational movement only between the capturing of the first and the second image frame: determining whether any objects in the first and/or second image frame are close to the camera of the camera device; if it is determined that no object in the first and/or the second image frame is close to the camera; and generating an identical copy of the first or the second image frame to obtain an intermediate image frame, or skipping to generate any intermediate copy; if it is determined that an object in the first and/or the second image frame is close to the camera and an estimation of the motion based on optical flow data is available; generating an intermediate copy of the first image frame and the second image frame to obtain an intermediate image frame; if it is determined that an object in the first and/or the second image frame is close to the camera and no estimation of the motion based on optical flow data is available generating an identical copy of the first or the second image frame to obtain an intermediate image frame, or skipping to generate any intermediate copy.

In some embodiments, close objects are detected in a current image frame to determine if making a transformed copy of the image is good or not. If an object is close to the camera, a small motion of the camera, or motion of the object, will give rise to a great movement of the object between two image frames. Thus, if the relative motion of the object in view of the camera is large, then the object is deemed as being (too) close. Closeness in this context refers to the perceived proximity or apparent size of an object or subject within an image.

This perceived closeness is a function of both the actual distance of the object from the camera (object-to-camera distance) and the focal length of the apparatus used to capture the image, with the perceived closeness increasing with the focal length. In some embodiments, if the object is deemed to have a translational motion between two consecutive frames after the transforms have been added that is greater than 1 pixel, then the object is deemed to be close. If translational motion (movement) is less than 1 pixel between two frames, then the object is not considered as close. For rotational motion, close objects are not that much of an issue, and hence only the translational motion is regarded. In some instances, determining whether any objects in the current image frame are close to the camera of the camera device comprises analyzing one or more of: inertial measurement unit data, optical flow data and depth map data, or a combination thereof.

In one aspect, one is not only interested in determining a number of frames to be copied, but also which frames to use for the copy, especially for a single raw copy of a frame. Thus, for an intermediate frame being a raw copy, either the previous or the following frame may be copied. Thus, one may look at if a first frame or a second frame has better image quality (less movement), and select said image frame to copy, and insert between the first and the second frame, such that the intermediate frame is a copy of the following image frame, instead of the previous image frame, in the second stream of image frames. To copy either the previous or the following image frame, maybe determined based on their motion parameters, where the first (also sometimes referred to as “current”) and the second (following) image frames are two directly consecutive frames in the first stream of image frames.

Typically, as default, the first image frame will be selected as basis for the intermediate or identical “raw copy” added as an intermediate frame. However, some instances, one may look at the quality of the image, and choose to not make a copy, or make a copy of the second image frame instead, as mentioned above. Thus, in some embodiments, the method comprising: on condition that the motion parameters of the first image frame do not indicate significant movement of the camera device during capturing of said first image frame; and generating an intermediate or identical copy of the first image frame to obtain an intermediate image frame;
on condition that the motion parameters of the first image frame indicate significant movement of the camera device during capturing of said first image frame; and comparing the motion parameters of the first image frame and the second image frame, to determine which of the image frames that had the lowest motion when being captured; selecting the image frame having the lowest motion; and generating an intermediate or identical copy of the selected image frame to obtain an intermediate image frame. Typically, the frame deemed to have the lowest motion during capture is the one that show the smallest effect on the pixels of the image. Significant movement in this regard would be movement above a preset threshold, which threshold would depend on the application and desired/required image/video quality. Thus, when the movement exceeds the threshold, the movement is seen as significant. As the threshold is set based on the application and/or desired quality, the skilled person would be able to determine the threshold, and thus what would be significant in for a respective application.

In some embodiments, each intermediate frame is an intermediate copy of a first and/or a second image frame, or an identical copy of a first or second image frame. In some embodiments, more than one intermediate frame is inserted after each selected first image frame. Thus, several copies (identical, equally transformed or partly transformed) may be added. The added image frames may be identical to each other, or the motion between the first and second image frame may be divided between them. As an example, if two frames are added, ⅓ of the motion between the first and second image frame may be present in the first intermediate image frame, and ⅔ of the motion in the second intermediate image frame. In some embodiments, more than one copy of an image frame may be added after said copied image frame, i.e. one or more intermediate frames are added after each selected current image frame in the first stream of image frames to obtain the second stream of image frames.

The camera device comprises one or more motion sensors, which may track/detect the global motion of the camera device, i.e. the motion of the device/camera itself, which thus are reflected on the captured image frames on a global scale (i.e. the whole image frame experience said motion). The one or more motion sensors are selected from a gyroscope sensor, an accelerometer sensor and a magnetometer sensor. The motion sensor may comprise an IMF providing IMF data. Alternatively, or additionally, the camera device comprise a software, which estimates the global motion of the camera device based on optical flow data.

An intermediate frame may be an intermediate copy of a first and/or a second image frame, the intermediate frame being generated by transforming a copy of the first image based on the motion information of the camera device, the motion information comprising information regarding the motion of the camera device between capturing of the first and the second image frame, such that the intermediate frame comprises a part of the motion of the camera device that has occurred after half of the time between capturing of the first and the second image frame. Thus, the copy of the first image is transformed based on the motion of the camera device between said images, such that the global alignment of the intermediate image is located between the corresponding global alignment of the first and the second image frame.

In some aspects, the methods may further comprise encoding (S4) the second stream of image frames; and transmitting (S5) the encoded second stream of image frames to a recipient device, such as a display device. The methods may be used for live streaming purposes, or may be used for a video file to be stored.

### Example Device Configurations

Turning now to FIG. 2, which is a schematic block diagram that illustrates some modules of an example embodiment of a camera device being configured for enhancing video output quality for a captured video sequence. The camera device is configured to implement all aspects of the methods described in relation to FIG. 1.

The camera device 10 comprises a camera 11, configured for capturing a video sequence. It further comprises one or more motion sensors 12 for monitoring the motion of the camera device and/or software for estimating the motion, and thus the camera, during capturing of the video. The camera device further comprises a memory 13 for storing the video sequence, and instructions for performing the current methods. The camera device further comprises a communication interface 14, such as a radio communication interface (i/f) configured for communication with another device, such as a recipient device. The radio communication interface 14 may be adapted to communicate over one or several radio access technologies.

The camera device 10 comprises a controller, CTL, or a processing circuitry 15 that may be constituted by any suitable Central Processing Unit, CPU, microcontroller, Digital Signal Processor, DSP, etc. capable of executing computer program code. The computer program may be stored in a memory, MEM 13. The memory 13 can be any combination of a Read And write Memory, RAM, and a Read Only Memory, ROM. The memory 13 may also comprise persistent storage, which, for example, can be any single one or combination of magnetic memory, optical memory, or solid state memory or even remotely mounted memory.

According to some aspects, the disclosure relates to a computer program comprising computer program code which, when executed, causes a camera device to execute the methods described above and below. According to some aspects the disclosure pertains to a computer program product or a computer readable medium holding said computer program. In some embodiments, the processing circuitry 15 may further comprise both a memory 13 storing a computer program and a processor 16, the processor being configured to carry out the method of the computer program.

One embodiment includes camera device (10), configured to enhance video output quality for a captured video sequence, the device comprising: a camera (11), one or more motion sensors and/or software (12), a memory (13), a communication interface (14), and processing circuitry (15) configured to cause the camera device (10) to: capture, using the camera, a video sequence comprising a first stream of image frames at a first frame rate using a camera in the camera device; continuously monitor, using the one or more motion sensors, the motion of the camera device during the capture of the video sequence to obtain motion information, wherein the motion information comprises at least one motion parameter related to each image frame indicating a motion of the camera device during the capture of said image frame; add a number of intermediate frames in the first stream of image frames to obtain a second stream of image frames, wherein to add comprises: select a number of image frames from the first stream of image frames based on the motion parameters of the image frames; copy said selected image frames to obtain intermediate frames; insert the intermediate image frames in the first stream of image frames to obtain a second stream of image frames. In some aspects, the camera device is a mobile device, such as a smartphone, iPad, Tablet, headset, smart glasses or mobile terminal.

The content of this disclosure thus enables a camera device to capture a video sequence and enhance its video output quality, by adding copies of already existing image frames.

Aspects of the disclosure are described with reference to the drawings, e.g., block diagram and/or flowchart. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1. A method performed in a camera device, for enhancing video output quality for a captured video sequence, the camera device comprising one or more motion sensors and/or software to monitor or estimate motion of the camera device, method comprising:
capturing a video sequence comprising a first stream of image frames at a first frame rate using a camera in the camera device;
continuously monitoring the motion of the camera device, using the one or more motion sensors, during the capturing of the video sequence to obtain motion information, wherein the motion information comprises at least one motion parameter related to each image frame indicating a motion of the camera device during the capturing of said image frame; and
adding a number of intermediate frames in the first stream of image frames to obtain a second stream of image frames, wherein the adding comprises:
selecting a number of image frames from the first stream of image frames based on the motion parameters of the image frames;
copying said selected image frames to obtain intermediate frames; and
inserting the intermediate image frames in the first stream of image frames to obtain the second stream of image frames.

2. The method according to claim 1, wherein selecting a number of image frames from the first stream of image frames based on the motion parameters of the image frames comprises:
i) selecting all image frames in the first stream of image frames; or
ii) selecting a number of image frames in the first stream of image frames being fewer than a total number of image frames, wherein the frames being selected shows a greatest difference in the motion parameters between two consecutive image frames.

3. The method according to claim 1, for the selected image frames, wherein each image frame being selected to be followed by an added intermediate frame in the second stream of images is a first image frame, and each frame being a consecutive following image frame of a first frame in the first stream of image frames is a second image frame, the method further comprises:
for each first and second image frame in the first stream of image frames, on condition that the at least one motion parameter of the first image frame and the at least one motion parameter of second image frame indicate rotational movement only between the capturing of the first and the second image frame:
generating an intermediate copy of the first image frame and the second image frame to obtain an intermediate image frame; and
inserting the obtained intermediate image frame between the first and the second image frame in the second stream of image frames;
on condition that the at least one motion parameter of the first image frame and the at least one motion parameter of second image frame indicate both translational movement and rotational movement between the capturing of the first and the second image frame:
determining whether any objects in at least one of the first image frame the second image frame are close to the camera of the camera device;
if it is determined that no object in at least one of the first image frame the second image frame is close to the camera:
generating an intermediate copy of the first image frame and the second image frame to obtain an intermediate image frame; and
inserting the obtained intermediate image frame between the first and the second image frame in the second stream of image frames; and
if it is determined that an object in at least one of the first image frame the second image frame is close to the camera:
generating an identical copy of the first or the second image frame to obtain an intermediate image frame; and
inserting the obtained intermediate image frame between the first and the second image frame in the second stream of image frames;
on condition that the at least one motion parameter of the first image frame and the at least one motion parameter of second image frame indicate translational movement only between the capturing of the first and the second image frame:
determining whether any objects in at least one of the first image frame the second image frame are close to the camera of the camera device;
if it is determined that no object in at least one of the first image frame the second image frame is close to the camera,
generating an identical copy of the first image frame or the second image frame to obtain an intermediate image frame, or skipping to generate any intermediate copy;
if it is determined that an object in at least one of the first image frame the second image frame is close to the camera and an estimation of the motion based on optical flow data is available,
generating an intermediate copy of the first image frame and the second image frame to obtain an intermediate image frame; and
if it is determined that an object in at least one of the first image frame and/or the second image frame is close to the camera and no estimation of the motion based on optical flow data is available,
generating an identical copy of the first or the second image frame to obtain an intermediate image frame, or skipping to generate any intermediate copy.

4. The method according to claim 3, the method further comprising:
on condition that the motion parameters of the first image frame do not indicate significant movement of the camera device during capturing of said first image frame,
generating an intermediate or identical copy of the first image frame to obtain an intermediate image frame;
on condition that the motion parameters of the first image frame indicate significant movement of the camera device during capturing of said first image frame:
comparing the motion parameters of the first image frame and the second image frame, to determine which of the image frames that had the lowest motion when being captured;
selecting the image frame having the lowest motion; and
generating an intermediate or identical copy of the selected image frame to obtain an intermediate image frame.

5. The method according to claim 3, wherein determining whether any objects in the current image frame are close to the camera comprises analyzing one or more of: inertial measurement unit data, optical flow data and depth map data, or a combination thereof.

6. The method according to claim 3, wherein more than one intermediate frame is inserted after each selected first image frame in the first stream of image frames to obtain the second stream of image frames.

7. The method according to claim 1, wherein the one or more motion sensors detect the global motion of the camera device, and/or wherein the software estimates the global motion of the camera device based on optical flow data.

8. The method according to claim 1, wherein the one or more motion sensors are selected from a gyroscope sensor, an accelerometer sensor and a magnetometer sensor.

9. The method according to claim 3, wherein each intermediate frame is an intermediate copy of a first or a second image frame, or an identical copy of a first or second image frame.

10. The method according to claim 9, wherein the intermediate frame is an intermediate copy of a first or a second image frame, the intermediate frame being generated by transforming a copy of the first image based on the motion information of the camera device, the motion information comprising information regarding the motion of the camera device between capturing of the first and the second image frame, such that the intermediate frame comprises a part of the motion of the camera device that has occurred after half of the time between capturing of the first and the second image frame.

11. The method according to claim 1, further comprising:
encoding the second stream of image frames; and
transmitting the encoded second stream of image frames to a recipient device.

12. A camera device, configured to enhance video output quality for a captured video sequence, the device comprising:
a camera,
one or more motion sensors and/or software,
a memory,
a communication interface, and
processing circuitry configured to cause the camera device to: capture, using the camera, a video sequence comprising a first stream of image frames at a first frame rate using a camera in the camera device;
continuously monitor, using the one or more motion sensors, the motion of the camera device during the capture of the video sequence to obtain motion information, wherein the motion information comprises at least one motion parameter related to each image frame indicating a motion of the camera device during the capture of said image frame;
add a number of intermediate frames in the first stream of image frames to obtain a second stream of image frames, wherein to add comprises:
select a number of image frames from the first stream of image frames based on the motion parameters of the image frames;
copy said selected image frames to obtain intermediate frames;
insert the intermediate image frames in the first stream of image frames to obtain a second stream of image frames.

13. The camera device according to claim 12, wherein the camera device is a mobile device.

14. A non-transitory computer readable storage medium storing computer program code which, when executed in a camera device, causes the camera device to execute the method according to claim 1.

15. (canceled)
